(19) United States
(12) Patent Application Publication
(10) Pub. No.: US 2010/0077385 A1
(43) Pub. Date: Mar. 25, 2010

(54) DEBUGGER EXCEPTION FILTERING WITH TARGET-BASED RULES

(75) Inventors: Javier Nisim Flores Assad, Bothell, WA (US); Michael Hung-Hsiang Chen, Bellevue, WA (US); John Robert Eldridge, Bellevue, WA (US); Gregory Hogdal, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/236,174

(22) Filed: Sep. 23, 2008

(51) Int. Cl. G06F 9/44

(52) U.S. Cl. 717/129

(57) ABSTRACT

Filtering exceptions on a target computing device to selectively interrupt a host computing device based on rules. The rules represent user-defined scenarios, and each rule includes one or more criteria and a break decision. Upon detecting an exception on the target computing device, the target computing device evaluates the rules based on the criteria and information about the exception without notifying the host computing device. For example, a score is calculated for each rule, and the rule with the highest score is selected. The break decision associated with the selected rule is applied. For example, the break decision indicates that the exception is of interest and the host computing device should be notified, or that the exception does not match a scenario of interest and execution should continue without a break.

### BACKGROUND

Existing kernel debugger systems debug an operating system or application program executing on a target device connected to a host device. In some systems, as exceptions occur, a developer is prompted on the host device to manually break into a debug session or continue execution. Further, developers have limited ability to automate the exception filtering (e.g., ignore or only break on specific exceptions). For example, in existing systems, the developer can only specify to ignore or allow exceptions of a certain type or exception code, or to ignore exceptions from certain processes.

When the developer is debugging in a kernel debugger, however, the developer typically wants to ignore or allow exceptions matching specific scenarios. Additionally, the limited exception filtering in existing systems fails if the operating system being debugged uses processes to host code from other parties. Further, existing solutions perform the filtering logic on the host device, which causes the operating system real-time scheduling to halt while the host device is notified of the exception.

### SUMMARY

Embodiments of the invention provide selective exception filtering based on rules stored on a target computing device coupled to a host computing device. One or more rules are defined to have one or more criteria and a break decision. The target computing device executes instructions, and receives notification of an exception resulting from the execution. The rules are evaluated to select one of the rules with criteria met by information about the exception, without notifying the host computing device. The break decision associated with the selected rule (e.g., continue execution, or break and notify the host computing device) is applied.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a user interacting with a target computing device connected to a host computing device.

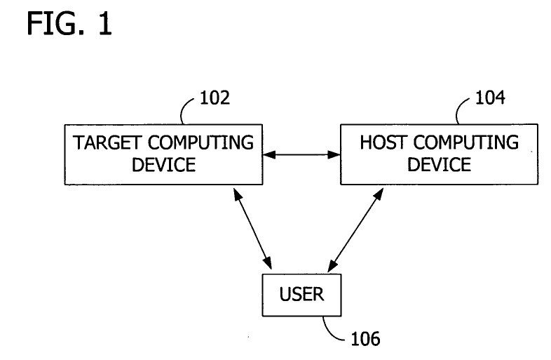

FIG. 2 is an exemplary block diagram illustrating the target computing device storing rules and components for implementing aspects of the invention.

FIG. 3 is an exemplary block diagram illustrating the evaluation of rules by the target computing device to determine whether to notify the host computing device.

FIG. 4 is an exemplary flow chart illustrating calculating a score for each rule to determine a break decision to apply.

FIG. 5 is an exemplary flow chart illustrating rule evaluation and modification during runtime on the target computing device.

Corresponding reference characters indicate corresponding parts throughout the drawings.

### DETAILED DESCRIPTION

Referring to the figures, embodiments of the invention provide exception filtering based on rules 206 describing scenarios of interest to a developer. In some embodiments, the developer or other user 106 interacts with a host computing device 104 to debug instructions executing on a target computing device 102. A kernel debugger, or other debugger, also executes on the target computing device 102 and communicates with a debugger executing on the host computing device 104. In some embodiments (not shown), a network communicatively couples the target computing device 102 and the host computing device 104. The kernel debugger executing on the target computing device 102 evaluates the rules 206 entirely on the target computing device 102 side (e.g., without invoking the host computing device 104). This enables the filtering of exceptions deemed non-important by the user 106. Further, processing the rules 206 on the target computing device 102 reduces the interruption time caused by exceptions that the user 106 deems not important. Aspects of the invention are applicable to debugging real-time operating systems, among other instructions.

In some embodiments, the target computing device 102 is a mobile telephone and the host computing device 104 is a personal computer. However, while some embodiments of the invention are applicable to the mobile telephone, aspects of the invention are operable with other computing devices. For example, the target computing device 102 and/or the host computing device 104 include, but are not limited to, personal computers, server computers, digital cameras, portable music players, gaming consoles, hand-held or laptop devices, multiprocessor systems, microprocessor-based systems, set top boxes, programmable consumer electronics, network computers, minicomputers, mainframe computers, and distributed computing environments that include any of the above systems or devices, and the like.

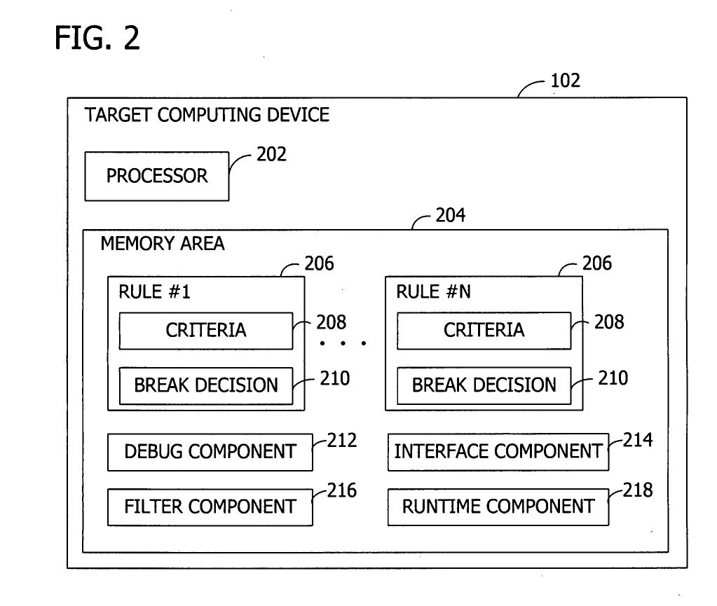

Referring next to FIG. 2, an exemplary block diagram illustrates the target computing device 102 having computer-executable components for implementing aspects of the invention. The target computing device 102 includes a processor 202 and a memory area 204. The memory area 204, or other computer-readable medium, stores one or more rules 206 for exception filtering, such as rule #1 through rule #N. Each of the rules 206 has one or more criteria 208 and a break decision 210 associated therewith. The criteria 208 provide contextual information to describe exceptions of interest to the user 106. The criteria 208 comprise fields, conditions, or other data such as an exception code (e.g., an identifier), a host process (e.g., a name), a host module (e.g., a name), a handling level (e.g., an identifier), an exception address range (e.g., a hexadecimal value), and the break decision 210. However, other criteria 208 are within the scope of the invention, and the criteria 208 are user-configurable particular to the set of rules 206. For example, an additional criterion 208 includes the arguments passed during a function call, or configuration data for the processor 202.

If one of the rules 206 has most of the fields completed, this rule 206 describes a very specific exception scenario. If one of the rules 206 has few of the fields completed, this rule 206 describes a general exception scenario. In an example scenario, the user 106 wants to break as follows: “do not break on handled exceptions unless the exception is a stack overflow caused by myapp.exe or the exception was generated while inside mymodule.dll.” This example scenario maps to the following rules: 1. Do not break on any handled exceptions; 2. Break if the exception is a stack overflow in myapp.exe; and 3. Break if the exception was generated from mymodule.dll. The first rule is generic as it is applicable to all handled exceptions. The other two rules are more specific. Embodiments of the invention enable a set of the rules 206 with varying specificity or generality to be evaluated together to describe the exception that has occurred.

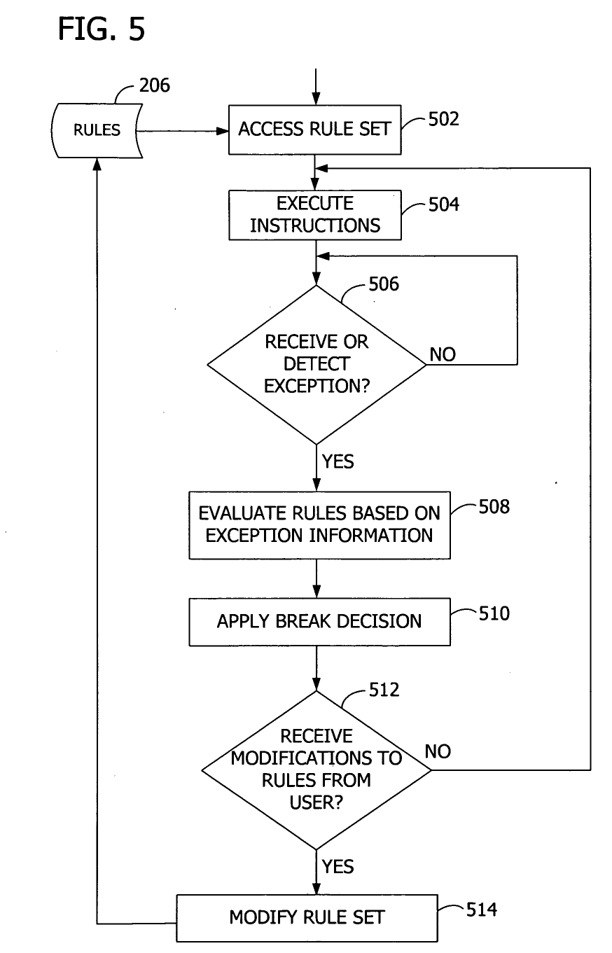

The memory area 204 further stores computer-executable components including a debug component 212, an interface component 214, a filter component 216, and a runtime component 218, which are described below with reference to FIG. 5.

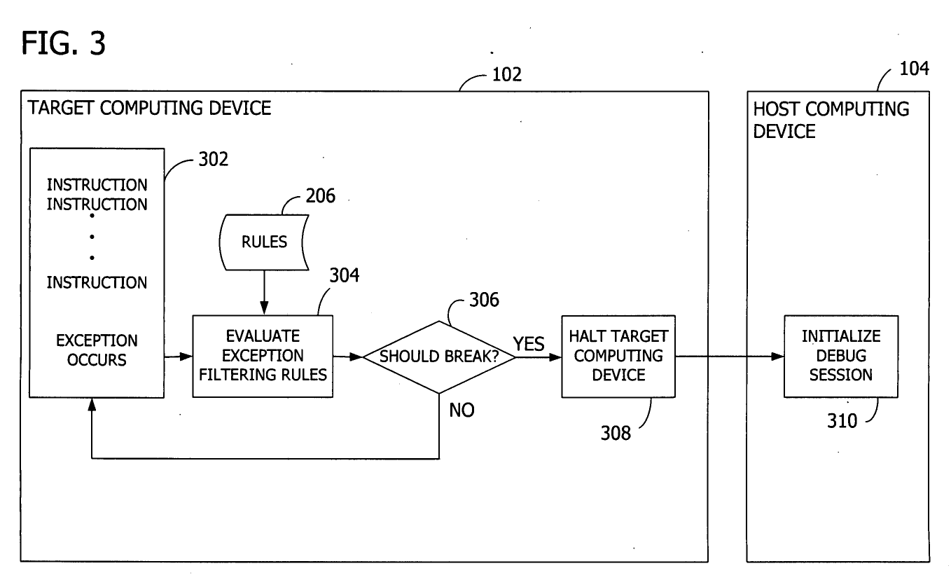

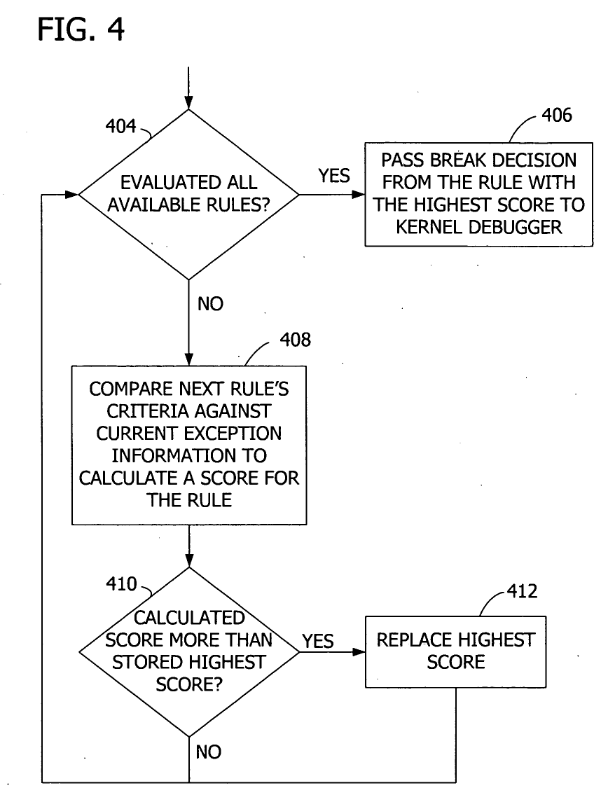

In an embodiment, the processor 202 is transformed into a special purpose microprocessor by executing computer-executable instructions or by otherwise being programmed. For example, the processor 202 executes computer-executable instructions for performing the operations illustrated in FIG. 3, FIG. 4, and FIG. 5.

Referring next to FIG. 3, an exemplary block diagram illustrates the evaluation of rules 206 by the target computing device 102 to determine whether to notify the host computing device 104 of an exception. The target computing device 102 executes a plurality of instructions until an exception occurs at 302. The kernel executing on the target computing device 102 notifies the kernel debugger hosted in the target computing device 102 of the exception. The notification received by the kernel debugger includes exception information describing the exception. The rules 206 are evaluated at 304 in view of the exception information. Evaluating the rules 206 includes, for example, comparing and matching the criteria 208 for each of the rules 206 to the exception information. The kernel debugger selects one of the rules 206 based on the evaluation at 304, without notifying the host computing device 104. Embodiments of the invention are operable with various means for selecting one of the rules 206. For example, the rule 206 having the most matched criteria 208 (or greatest quantity of matched criteria 208) is selected (e.g., +1 for each matching criteria 208 or field). Alternatively, each of the criteria 208 may be weighted separately, and the rule 206 with the greatest summed weights of matching criteria 208 is selected. Other means for selecting one of the rules 206 are within the scope of the invention.

The break decision 210 associated with the selected rule 206 is then applied, performed, or otherwise implemented. If a break should not occur at 306, the exception is ignored and execution of the instructions continues at 302 without interrupting the real-time scheduling on the host computing device 104. If a break should occur at 306 based on the break decision 210 associated with the selected rule 206, the target computing device 102 halts at 308 and the host computing device 104 is notified that an exception has occurred. The host computing device 104 initiates a debug session at 310 based on the exception.

Referring next to FIG. 4, an exemplary flow chart illustrates calculating a score for each rule 206 to determine the break decision 210 to apply. The embodiment of FIG. 4 illustrates one example of identifying or determining the break decision 210 (e.g., whether to ignore the exception, or halt execution and notify the host computing device 104), among many other examples within the scope of embodiments of the invention. The rules 206 may be evaluated in various ways. For example, the rules 206 may be evaluated in any order, or in a particular order defined by the developer or user 106 to identify the rule 206 with the highest score or value. The break decision 210 associated with that rule 206 becomes the determined break decision 210 to apply. In the scoring example of FIG. 4, more than one rule 206 may have contextual information relevant to the current exception, but only one rule 206 will be selected based on the criteria 208 associated with each of the rules 206.

In the example of FIG. 4, if all the rules 206 have not been evaluated at 404, the criteria 208 associated with the next rule 206 are accessed and compared against the exception information at 408. The comparison results in calculation of a score for the rule 206. Each rule 206 is evaluated against the exception information or context for the exception one-at-a-time and within each rule 206, each of the criteria 208 is compared one-at-a-time.

For example, the calculation is performed by summing values associated with each of the criteria 208 matching the exception information. The score represents how specifically the rule 206 matches the encountered exception. If the calculated score of the rule 206 is greater than a currently-stored highest score at 410, the highest score is replaced with the calculated score, and the determined break decision 210 is updated with the break decision 210 associated with the rule 206 at 412. If the calculated score of the rule 206 is not greater than the currently-stored highest score at 410, the next rule 206 is accessed at 404. If all the rules 206 have been evaluated at 404, the determined break decision 210 is passed to the kernel debugger executing on the target computing device 102 at 406. The kernel debugger applies the determined break decision 210.

In an embodiment, if two or more rules 206 have the same score, the rule 206 that is first declared within the set of the rules 206 takes precedence. In this way, the user 106 can prioritize the rules 206 based on the completed fields within each rule 206.

In an example application of the operations in FIG. 4, the following rules apply: 1. Do not break on any handled exceptions; 2. Break if the exception is a stack overflow in myapp.exe; and 3. Break if the exception was generated from mymodule.dll. The following exception occurs: “Handled access violation exception in myapp.exe while inside mymodule.dll.” The evaluation of the rules occurs as follows: Rule #1 refers to handled exceptions so it receives a score of +1; Rule #2 is specific to stack overflows so it does not match the current situation (e.g., automatic score of zero); Rule #3 refers to handled exceptions that occur inside mymodule.dll so it receives a score of +2. In this case, Rule #3 is applied, so the kernel debugger on the target computing device 102 breaks into the debugger on the host computing device 104.

In some embodiments, if all the rules 206 have a score of zero, the default behavior is to break into the debugger.

Referring next to FIG. 5, an exemplary flow chart illustrates rule 206 evaluation and modification during runtime on the target computing device 102. With reference again to the computer-executable components illustrated in FIG. 2, the kernel debugger executing on the target computing device 102 includes the debug component 212, the interface component 214, the filter component 216, and the runtime component 218. The debug component 212 accesses the rules 206 or rule set at 502. For example, the debug component 212 accesses the rules 206 specific to the plurality of instructions to be executed. In such embodiments, there are separate rule sets for each grouping of instructions (e.g., separate rules 206 for each application program or operating system level logic being debugged). In general, the rules 206 (and criteria 208) enable the user 106 to describe exceptions of interest.

The target computing device 102 executes a plurality of instructions at 504. If an exception is detected or notification of an exception is received at 506 by the interface component 214 (e.g., from a kernel executing on the target computing device 102), the rules 206 are evaluated at 508 by the filter component 216 based on exception information associated with the exception. For example, the criteria 208 associated with each of the rules 206 are compared to the exception information. Based on the evaluation at 508, one of the rules 206 is selected. The break decision associated with the selected rule 206 is determined without notifying the host computing device 104 and applied at 510.

The runtime component 218 interacts with the user 106 to receive modifications to the rules 206 from the user 106 or developer at 512. If modifications are received at 512, the user 106 dynamically modifies the rules 206 stored on the target computing device 102 at 514. The runtime component 218 enables the modification without notifying the host computing device 104. For example, the runtime component 218 includes a user interface for presenting the rules 206 and associated criteria 208, and receiving the modifications from the user 106. The modifications include, but are not limited to, adding a rule 206, deleting a rule 206, editing a rule 206, adding criteria 208 to a rule 206, removing criteria 208 from a rule 206, or editing the criteria 208 associated with a rule 206.

### Exemplary Operating Environment

A computer or computing device such as described herein has one or more processors or processing units, system memory, and some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

The embodiments illustrated and described herein as well as embodiments not specifically described herein but within the scope of aspects of the invention constitute exemplary means for selectively notifying the host computing device 104 of the exception based on the rules 206, and exemplary means for defining the criteria 208 in the rules 206 to describe exceptions of interest to the user 106 of the target computing device 102.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for exception filtering on a mobile computing device connected to a host computing device, said host computing device debugging instructions executing on the mobile computing device, said system comprising:
a memory area for storing one or more rules for exception filtering, each of said rules having one or more criteria and a break decision associated therewith, said memory area being associated with the mobile computing device; and
a processor associated with the mobile computing device, said processor programmed to:
receive notification of an exception resulting from execution of an instruction on the mobile computing device, said notification including exception information describing the exception;
access the rules stored in the memory area;
compare the exception information to the criteria for each of the rules;
calculate a score for each of the rules based on the comparison;
select one of the rules based on the calculated scores without notifying the host computing device; and
apply the break decision associated with the selected rule.

2. The system of claim 1, wherein the processor is programmed to calculate the score by summing values associated with each of the criteria based on the comparison.

3. The system of claim 1, wherein the processor is further programmed to evaluate the criteria based on the exception information.

4. The system of claim 1, wherein the score comprises a value, and wherein the processor is programmed to select one of the rules by selecting the rule having the greatest value.

5. The system of claim 1, wherein the criteria corresponds to contextual information.

6. The system of claim 1, wherein the processor is programmed to implement the break decision by notifying the host computing device of the exception.

7. The system of claim 1, further comprising means for selectively notifying the host computing device of the exception based on the rules.

8. The system of claim 1, further comprising means for defining the criteria in the rules to describe exceptions of interest to a user of the mobile computing device.

9. A method comprising:
defining one or more rules for exception filtering, each of said rules having one or more criteria and a break decision associated therewith, said rules being stored on a target computing device coupled to a host computing device;
executing, by the target computing device, an instruction;
receiving notification of an exception resulting from said executing, said notification including exception information describing the exception;
evaluating the defined rules based on the exception information;
selecting one of the rules based on said evaluating without notifying the host computing device; and
implementing the break decision associated with the selected rule.

10. The method of claim 9, wherein implementing the break decision comprises notifying the host computing device of the exception.

11. The method of claim 9, wherein implementing the break decision comprises resuming execution of the instruction without notifying the host computing device of the exception.

12. The method of claim 9, wherein defining the rules comprises defining one or more of the following: an exception code, a host process, a host module, a handling level, an exception address range, and the break decision.

13. The method of claim 9, wherein evaluating the rules comprises matching the criteria to the exception information.

14. The method of claim 13, wherein selecting one of the rules comprises comparing each of the rules based on the matched criteria to identify one of the rules with a defined quantity of matched criteria.

15. One or more computer-readable media having computer-executable components implementing a kernel debugger, said components comprising:
a debug component for accessing one or more rules for exception filtering, each of said rules having one or more criteria and a break decision associated therewith, said rules being stored on a target computing device coupled to a host computing device for debugging, wherein the target computing device executes a plurality of instructions;
an interface component for receiving notification of an exception resulting from execution of the instructions, said notification including exception information describing the exception;
a filter component for evaluating the rules accessed by the debug component based on the exception information to identify a break decision associated therewith without notifying the host computing device, wherein the filter component further applying the break decision associated with the selected rule; and
a runtime component for enabling a user to dynamically modify the rules stored on the target computing device without notifying the host computing device.

16. The computer-readable media of claim 15, wherein the debug component accesses one or more rules specific to the plurality of instructions.

17. The computer-readable media of claim 15, wherein the interface component receives the notification from a kernel in the target computing device.

18. The computer-readable media of claim 15, wherein the filter component evaluates the rules by comparing the criteria to the exception information.

19. The computer-readable media of claim 15, wherein the debug component, the interface component, the filter component, and the runtime component collectively comprise a kernel debugger.

20. The computer-readable media of claim 15, wherein the debug component accesses the rules to enable the filter component to identify exceptions of interest to the user of the target computing device.
